(19) United States
(12) Patent Application Publication
(10) Pub. No.: US 2016/0085408 A1
(43) Pub. Date: Mar. 24, 2016

(54) INFORMATION PROCESSING METHOD AND ELECTRONIC DEVICE THEREOF

(71) Applicants: BEIJING LENOVO SOFTWARE LTD., Beijing (CN); LENOVO (BEIJING) LIMITED, Beijing (CN)

(72) Inventors: Jian LANG, Beijing (CN); Xiaoping ZHANG, Beijing (CN)

(73) Assignees: LENOVO (BEIJING) LIMITED, Beijing (CN); BEIJING LENOVO SOFTWARE LTD., Beijing (CN)

(21) Appl. No.: 14/636,414

(22) Filed: Mar. 3, 2015

(30) Foreign Application Priority Data
Sep. 22, 2014 (CN) 201410488536.2

(51) Int. Cl. G06F 3/0481; G06F 3/0485; G06F 17/22

(52) U.S. Cl. CPC G06F 3/04812; G06F 17/2235; G06F 3/0485

(57) ABSTRACT

The application provides an information processing method and an electronic device. The information processing method comprises: monitoring location information of a characteristic point with respect to a first interface displayed on a first electronic device; determining whether the location information of the characteristic point satisfies a preset condition; and keeping the displayed content of the first interface unchanged, and pre-loading first data corresponding to the characteristic point if the location information of the characteristic point satisfies the preset condition, so as to enable second content corresponding to the pre-loaded first data to be displayed on the first electronic device upon the first electronic device receives a switching operation corresponding to the first data.

### CROSS REFERENCE TO RELATED APPLICATIONS

This application claims the benefit and priority of a Chinese Patent Application Serial Number 201410488536.2 filed on Sep. 22, 2014, which is incorporated herein by reference.

### TECHNICAL FIELD

The application relates to the field of electronic techniques, and in particular to an information processing method and an electronic device thereof.

### BACKGROUND

With the development of electronic techniques, networks and various electronic devices with different functions come into people's life. Applications such as electronic books and browsers are used by people to acquire a great deal of data and information in real time.

Nowadays, due to the limited display area of the electronic device and increasing data contents, in order to facilitate a user viewing data by using the electronic device, typically only a part of the data is displayed on an application interface, and interactive controls such as links, paging buttons or pulling-down bars are provided on the application interface so that the user may perform a switching operation to trigger an interactive control and then remaining data contents are loaded and displayed.

However, at least the following technical problems were founded in the above techniques. When the user performs a switching operation to trigger an interactive control, the electronic device is required to load corresponding data firstly, and then displays the loaded data. Therefore, after the execution of the switching operation, the user needs to wait a long data loading time before viewing the displayed corresponding data.

Or said differently, the duration of time from the electronic device receiving a switching operation for displaying data to the data being displayed is too long.

### SUMMARY

Embodiments of the application provide an information processing method and an electronic device thereof.

As an aspect, embodiments of the application provide the following technical solution:

an information processing method, comprising:
monitoring location information of a characteristic point with respect to a first interface displayed on a first electronic device;
determining whether the location information of the characteristic point satisfies a preset condition; and
keeping the displayed content of the first interface unchanged, and pre-loading first data corresponding to the characteristic point if the location information of the characteristic point satisfies the preset condition, so as to enable second content corresponding to the pre-loaded first data to be displayed on the first electronic device upon the first electronic device receiving a switching operation corresponding to said first data.

Optionally, monitoring the location information of the characteristic point with respect to the first interface comprises: collecting second data, the second data being data representative of a visual focus area of a viewer; analyzing the second data to determine a visual focus point with respect to the first interface; and monitoring location information of the visual focus point with respect to the first interface.

Optionally, monitoring the location information of the characteristic point with respect to the first interface comprises: detecting a location point of a first operation with respect to the first interface, wherein the switching operation is a successive operation of the first operation, the first operation being used for determining a location corresponding to the switching operation before the switching operation is received; and monitoring location information of the location point with respect to the first interface.

Optionally, determining whether the location information of the characteristic point satisfies a preset condition comprises: determining whether the characteristic point is located within a first predetermined area of the first interface; or determining whether the time during which the characteristic point is located within the first predetermined area of the first interface has reached a preset duration of time.

Optionally, the first predetermined area comprises: an area for which the distance from a preset side of the first interface is below a preset threshold; or an area with a first link displayed therein.

Optionally, pre-loading the first data corresponding to the characteristic point comprises: loading the first data related to third data displayed in the first predetermined area into a storage unit, wherein the first data and the third data are preset data successively displayed on the first interface.

Optionally, in the case that the preset side comprises a first preset side and a second preset side, the first data are preset data previous to the third data if the distance between the characteristic point and the first preset side is below the preset threshold; and the first data are preset data following the third data if the distance between the characteristic point and the second preset side is below the preset threshold.

Optionally, if the first predetermined area comprises an area with a first link displayed therein, pre-loading the first data corresponding to the characteristic point comprises: loading the first data which correspond to data relating to the first link, into a storage unit so that the first data can be read directly from the storage unit and displayed when the first link is triggered by the switching operation.

Optionally, pre-loading the first data corresponding to the characteristic point comprises: sending a loading request to a second electronic device connected with the first electronic device; receiving the first data sent from the second electronic device based on the loading request; and storing the first data in a storage unit.

Optionally, pre-loading the first data enables the second content corresponding to the first data to be displayed after a first period of time upon the first electronic device receives the switching operation corresponding to said first data, the first period of time being shorter than a second period of time required for displaying the second content after the switching operation is received in the case that said pre-loading is not performed.

As another aspect, embodiments of the application further provide an electronic device, comprising:

a display unit for displaying a first interface;

a processor configured to:

monitor location information of a characteristic point with respect to the first interface;

determine whether the location information of the characteristic point satisfies a preset condition; and

keep the displayed content of the first interface unchanged, and pre-load first data corresponding to the characteristic point if the location information of the characteristic point satisfies the preset condition, so as to enable second content corresponding to the pre-loaded first data to be displayed via the display unit upon receiving a switching operation corresponding to the first data.

Optionally, the processor is further configured to: collect second data, the second data being data representative of a visual focus area of a viewer; analyze the second data to determine a visual focus point with respect to the first interface; and monitor location information of the visual focus point with respect to the first interface.

Optionally, the processor is further configured to: detect a location point of a first operation with respect to the first interface, wherein the switching operation is a successive operation of the first operation, the first operation being used for determining a location corresponding to the switching operation before the switching operation is received; and monitor location information of the location point with respect to the first interface.

Optionally, the processor is further configured to: determine whether the characteristic point is located within a first predetermined area of the first interface; or determine whether the time during which the characteristic point is located within the first predetermined area of the first interface has reached a preset duration of time.

Optionally, the first predetermined area comprises: an area for which the distance from a preset side of the first interface is below a preset threshold; or an area with a first link displayed therein.

Optionally, if the first predetermined area comprises an area for which the distance from a preset side of the first interface is below a preset threshold, the processor is further configured to load the first data related to third data displayed in the first predetermined area into a storage unit, wherein the first data and the third data are preset data successively displayed on the first interface.

Optionally, if the preset side comprises a first preset side and a second preset side, the first data are preset data previous to the third data if the distance between the characteristic point and the first preset side is below the preset threshold; and the first data are preset data following the third data if the distance between the characteristic point and the second preset side is below the preset threshold.

Optionally, if the first predetermined area comprises an area with a first link displayed therein, the processor is further configured to: load the first data which correspond to data relating to the first link, into a storage unit so that the pre-loaded first data can be read directly from the storage unit and displayed when the first link is triggered by the switching operation.

Optionally, the processor is further configured to: send a loading request to a second electronic device; receive the first data sent from the second electronic device based on the loading request; and store the first data in a storage unit.

Optionally, the processor is further configured to pre-load the first data to enable the second content corresponding to the pre-loaded first data to be displayed after a first period of time upon receiving the switching operation, the first period of time being shorter than a second period of time required for displaying the second content after receiving the switching operation in the case that said pre-loading is not performed

### BRIEF DESCRIPTION OF THE DRAWINGS

FIG. 1 is a flowchart of an information processing method according to the first embodiment of the application;

FIG. 2A is a first schematic diagram of a visual focus area and a visual focus point according to the first embodiment of the application;

FIG. 2B is a second schematic diagram of a visual focus area and a visual focus point according to the first embodiment of the application;

FIG. 3A is a first schematic diagram of a first operation and a location point according to the first embodiment of the application;

FIG. 3B is a second schematic diagram of according to first operation and a location point according to the first embodiment of the application;

FIG. 4 is a schematic diagram of a human-machine interaction according to the first embodiment of the application; and

FIG. 5 is a structural diagram of an electronic device according to the second embodiment of the application.

### DETAILED DESCRIPTION

Embodiments of the application address the technical problem of the prior art that the duration of time from the electronic device receiving a switching operation for displaying data to the data being displayed is too long, by providing an information processing method and an electronic device.

As an aspect, embodiments of the application provide the following technical solution.

There is provided an information processing method for use in a first electronic device, comprising:
monitoring location information of a characteristic point with respect to a first interface when the first interface is displayed on the first electronic device;
determining whether the location information of the characteristic point satisfies a preset condition; and
keeping the displayed content of the first interface unchanged, and pre-loading first data corresponding to the characteristic point if the location information of the characteristic point satisfies the preset condition, so as to enable second content corresponding to the pre-loaded first data to be displayed on the first electronic device upon the first electronic device receiving a switching operation corresponding to the first data.

Pre-loading the first data enables the second content corresponding to the first data to be displayed after a first period of time upon the first electronic device receives the switching operation corresponding to said first data, the first period of time being shorter than a second period of time required for displaying the second content after the switching operation is received in the case that said pre-loading is not performed.

It can be seen from the above content, location information of a characteristic point with respect to the first interface is monitored, and, when the location where the characteristic point is located satisfies a preset condition, first data corresponding to the characteristic point are loaded in advance, i.e. pre-loaded, so that the time for loading the first data is saved and the pre-loaded first data is displayed on the first application interface directly when the first electronic device receives a switching operation corresponding to the first data, thereby achieving the technical effect of improving the response speed of the switching operation.

In order to achieve a better understanding of the above solution, the solution will be described in detail, in connection with the figures and the embodiments. It should be understood that the embodiments of the application and specific features therein are illustrations of the solution of the application, rather than limitations of the solution of the application. Furthermore, the embodiments of the application and technical features therein can be combined without conflicts.

### First Embodiment

A first embodiment provides an information processing method for use in a first electronic device. In a practical application, the first electronic device may be an electronic device such as a smart phone, a tablet computer, a notebook computer or a smart watch, which will not be enumerated in this embodiment.

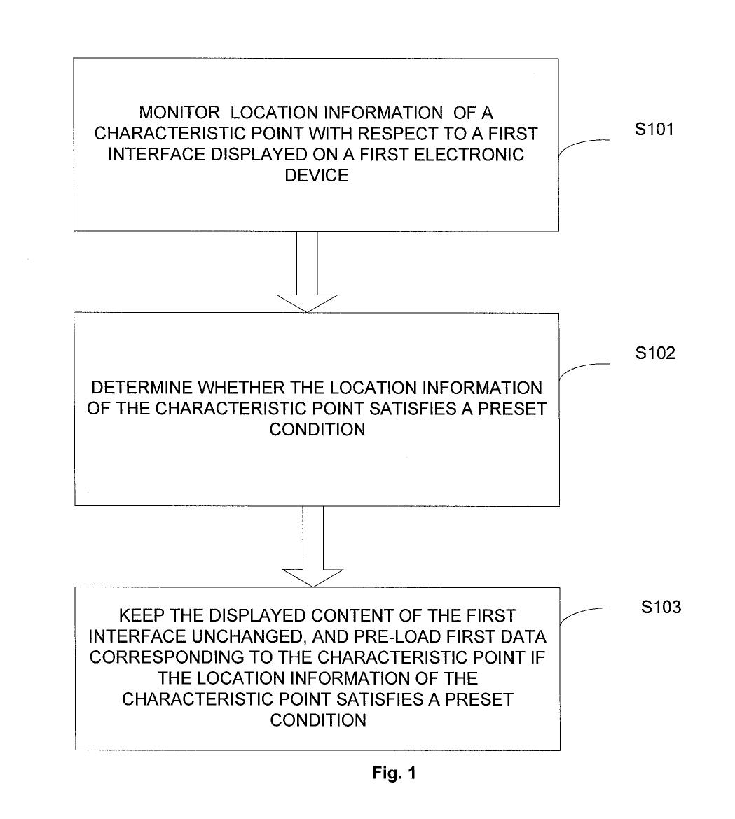

Referring to FIG. 1 which is a flowchart of an information processing method according to the first embodiment of the application, the method comprises:

Step S101, monitoring location information of a characteristic point with respect to a first interface when a first interface is displayed on the first electronic device;

Step S102, determining whether the location of the characteristic point satisfies a preset condition; and

Step S103, keeping the displayed content of the first interface unchanged, and pre-loading first data corresponding to the characteristic point if the location information of the characteristic point satisfies the preset condition, so as to enable second content corresponding to the pre-loaded first data to be displayed on the first electronic device upon the first electronic device receiving a switching operation corresponding to the first data. Pre-loading the first data enables the second content corresponding to the first data to be displayed after a first period of time upon the first electronic device receives the switching operation corresponding to said first data, the first period of time being shorter than a second period of time required for displaying the second content after the switching operation is received in the case that said pre-loading is not performed.

The implementation of steps of the method according to the embodiment of the application will be described in detail below.

Firstly, step S101 is performed, i.e. monitoring location information of a characteristic point with respect to a first interface when the first interface is displayed on the first electronic device.

In a particular implementation, the first interface may be a browser interface, or an interface of a reading application, or a game interface, which will not be limited in the embodiment.

In the embodiment of the application, according to the different characteristic points, the approach for monitoring location information of a characteristic point with respect to the first interface may at least comprise: monitoring a visual focus point, or monitoring a positioning operation location, which will be described in detail below.

The first one is to monitor a visual focus point.

That is, monitoring location information of the characteristic point with respect to the first interface comprises:

collecting second data, the second data being data representative of a visual focus area of a viewer;

analyzing the second data to determine a visual focus point with respect to the first interface; and

monitoring location information of the visual focus point with respect to the first interface.

In the embodiment of the application, the viewer may be a user or an image collection device, which will not be limited in the embodiment.

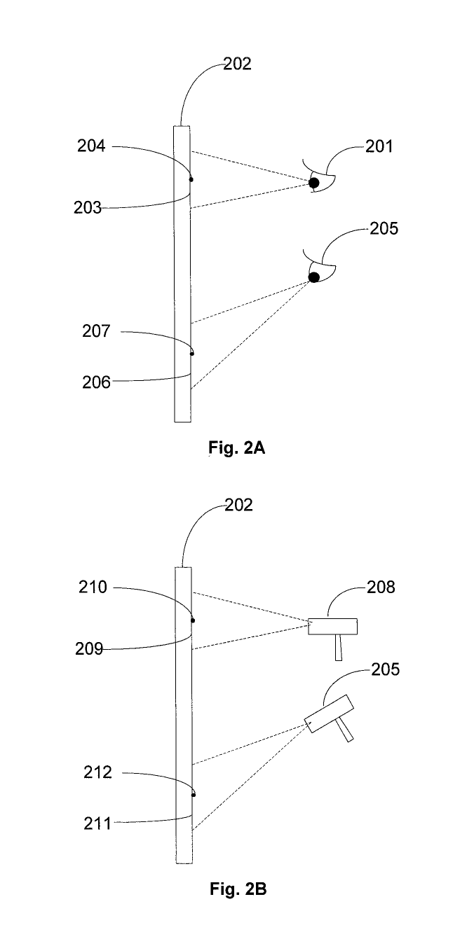

The visual focus area and the visual focus point will be described below, in connection with FIG. 2A and FIG. 2B.

As shown in FIG. 2A, when eyes 201 of a user A are viewing the first electronic device 202, the visual focus area is the first area 203 of the electronic device collected by the eyes, and the visual focus point may be the first center point 204 of the visual focus area. When eyes 205 of a user B are viewing the first electronic device 202, the visual focus area is the second area 206 of the electronic device collected by the eyes, and the visual focus point may be the second center point 207 of the visual focus area.

As shown in FIG. 2B, when a first image collection device 208 collects an image of the first electronic device 202, the visual focus area is the third area 209 of the electronic device collected by the first image collection device 208, and the visual focus point may be the third center point 210 of the visual focus area. When a second image collection device 211 collects an image of the first electronic device 202, the visual focus area is the fourth area 212 of the electronic device collected by the second image collection device 211, and the visual focus point may be the fourth center point 213 of the visual focus area.

Having knowledge of the visual focus area and the visual focus point, how to determine the visual focus point with respect to the first interface will be described below.

In the embodiment of the application, when the viewer is a user, the first collection unit may be a camera, and the corresponding second data may be eye image data of the eyes of the viewer captured by the camera. The first electronic device analyzes the location of the eyes of the viewer with respect to the first electronic device and the relative location of the eyeballs in the eyes according to the eye image data, and then calculates the visual focus area of the viewer on the first electronic device. Finally, the first electronic device determines the visual focus point with respect to a first interface according to the location of the first interface displayed on the display unit of the first electronic device and the visual focus area of the viewer on the first electronic device.

In the embodiment of the application, when the viewer is a user, the first collection unit may be an eye tracking apparatus with functions of infrared transmission/reception and/or functions of a camera, and the corresponding second data is data about the visual focus area of the viewer on the first electronic device captured by the eye tracking apparatus. The first electronic device determines the visual focus point with respect to a first interface according to the location of the first interface displayed on the display unit of the first electronic device and the visual focus area of the viewer on the first electronic device.

In the embodiment of the application, when the viewer is an image collection device, the first collection unit is a receiver, and the second data are image data captured by the image collection device and sent from the image collection device to the first collection unit. The first electronic device calculates the visual focus area of the viewer on the first electronic device according to the image data firstly, and then determines the visual focus point with respect to a first interface according to the location of the first interface displayed on the display unit of the first electronic device and the visual focus area of the viewer on the first electronic device.

The second one is to monitor the positioning operation location.

That is, monitoring location information of the characteristic point with respect to the first interface comprises:

detecting a location point of a first operation with respect to the first interface, wherein the switching operation is a successive operation of the first operation, the first operation being used for determining a location corresponding to the switching operation before the switching operation is received; and

monitoring location information of the location point with respect to the first interface.

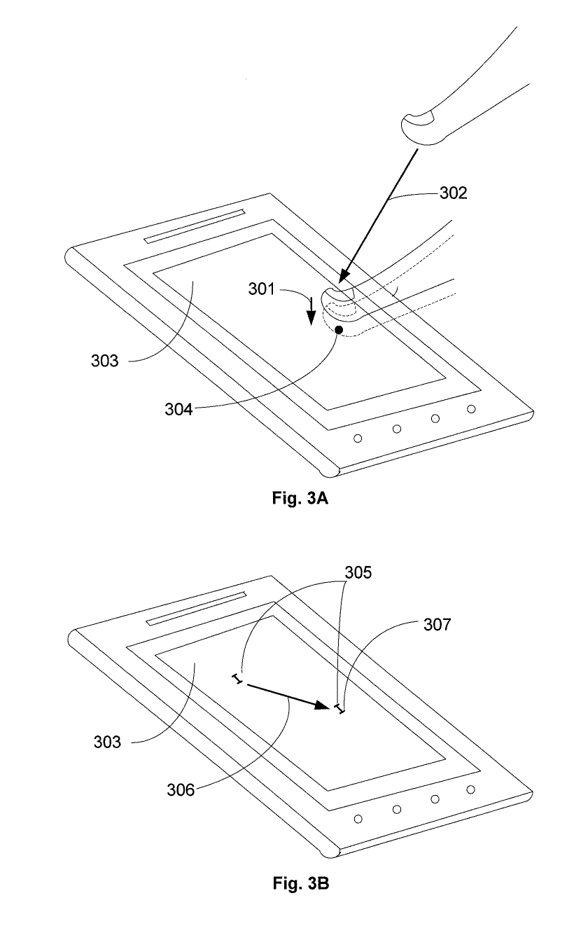

The first operation and the location point will be described below, in connection with FIG. 3A and FIG. 3B.

In the embodiment of the application, as shown in FIG. 3A, when the switching operation is a touch operation 301 of touching a touch screen by a finger, the first operation 302 is an approaching operation of moving a finger to approach the first interface on the touch screen 303, and the location point is a first point 304 near the location where the approaching operation approaches the first interface.

In the embodiment of the application, as shown in FIG. 3B, when the switching operation is a clicking operation of clicking a mouse on the first interface 303, the first operation is a moving operation 306 of moving a cursor 305 to a location where the switching operation needs to be performed, and the location point is a second point 307 to which the cursor is to be moved.

Having knowledge of the first operation and the location point, how to detect the location point of the first operation with respect to the first interface will be described below.

In the embodiment of the application, when the first operation is the approaching operation, a camera on the first electronic device obtains image data of a operating object such as a finger, the location of the operating object (such as, a finger) with respect to the first electronic device is calculated according to the image data, and then a point on the first interface having the shortest distance to the operating object is determined according to the relative location of the first interface on the display unit of the first electronic device and the relative location of the operating object with respect to the first electronic device. The point having the shortest distance is determined as the location point.

Alternatively, the first electronic device may be provided with a plurality of sensors. When the first operation is the approaching operation, in the procedure of the operating object approaching the first electronic device, one of the plurality of sensors senses the operating object. The location of the sensor sensing the operating object is determined as the location point.

In the embodiment of the application, when the first operation is a moving operation of moving a cursor, the first electronic device obtains the location of the cursor on the first interface, and determines the location of the cursor as the location point.

Particularly, because the first operation and the switching operation are successive operations and the first operation is prior to the switching operation, the first operation and the switching operation are the first half and the second half of one operation respectively. Therefore, as compared with the solution of triggering the loading of the corresponding first data after the switching operation which is the second half of the operation had been received, triggering the loading of the corresponding first data in advance according to the location of the first half of the operation with respect to the first interface can speed up display of the first data after the switching operation is received.

After monitoring location information of a characteristic point at step S101, step S102 is performed, i.e. determining whether the location information of the characteristic point satisfies a preset condition.

In the embodiment of the application, determining whether the location information of the characteristic point satisfies a preset condition comprises:

determining whether the characteristic point is located within a first predetermined area of the first interface; or

determining whether the time during which the characteristic point is located within the first predetermined area of the first interface has reached a preset duration of time.

In the embodiment of the application, the first predetermined area comprises:

an area for which the distance from a preset side of the first interface is below a preset threshold; or

an area with a first link displayed therein.

After the determination result was obtained at step S102, if the determination result is positive (yes), step S103 is performed, i.e. keeping the displayed content of the first interface unchanged, and pre-loading first data corresponding to the characteristic point, so as to enable second content corresponding to the pre-loaded first data to be displayed on the first electronic device upon the first electronic device receiving a switching operation corresponding to the first data. Pre-loading the first data enables the second content corresponding to the first data to be displayed after a first period of time upon the first electronic device receives the switching operation corresponding to said first data, the first period of time being shorter than a second period of time required for displaying the second content after the switching operation is received in the case that said pre-loading is not performed.

In the embodiment of the application, according to the different first predetermined area where the characteristic point is located, the approach for pre-loading the first data at least comprises: loading successive data, or loading linked data, which will be described respectively below.

The first one is to load successive data.

That is, when the first predetermined area is an area for which the distance from a preset side of the first interface is below a preset threshold, pre-loading first data corresponding to the characteristic point comprises: loading first data related to third data displayed in the first predetermined area into a storage unit, wherein the first data and the third data are preset data successively displayed on the first interface.

Particularly, the first data and the third data being preset data successively displayed on the first interface may means that they are data successive in time, i.e. the first data and the third data are data displayed in different pages on a preset first interface according to the order of time, for example, the data on pages n and n+1 of an e-book.

Taking the first interface being a reading interface of an e-book application as an example, the preset side may be the bottom side of the reading interface, and when the characteristic point is located within an area for which the distance from the bottom side is below a preset threshold, data on a next page following the page currently displayed on the reading interface are pre-loaded.

Taking the first interface being a browsing interface of a browser application as an example, the preset side may be the bottom side of the browsing interface, and when the characteristic point is located within an area for which the distance from the bottom side is below a preset threshold, successive data following the data displayed at the bottom of the browsing interface are pre-loaded.

Furthermore, the first electronic device may choose to pre-load different data according to the different locations where the characteristic point is located, i.e. when the preset side comprises a first preset side and a second preset side, the first data are preset data previous to the third data if the distance between the characteristic point and the first preset side is below the preset threshold; and the first data are preset data following the third data if the distance between the characteristic point and the second preset side is below the preset threshold.

Taking the first interface being the reading interface of an e-book application as an example, the first preset side may be the top side of the reading interface, and the second preset side may be the bottom side of the reading interface. When the characteristic point is located within an area for which the distance from the top side is below a preset threshold, data on the previous successive page preceding to the page currently displayed by the reading interface are pre-loaded; while when the characteristic point is located within an area for which the distance from the bottom side is below a preset threshold, data on the next successive page following the page currently displayed by the reading interface are pre-loaded.

Taking the first interface being a browsing interface of a browser application as an example, the first preset side may be the top side of the browsing interface, and the second preset side may be the bottom side of the browsing interface. When the characteristic point is located within an area for which the distance from the top side is below a preset threshold, previous data preceding to the data displayed at the top of the browsing interface are pre-loaded; while when the characteristic point is located within an area for which the distance from the bottom side is below a preset threshold, successive data following the data displayed at the bottom of the browsing interface are pre-loaded.

The second one is to load linked data.

That is, when the first predetermined area is an area with a first link displayed therein, pre-loading first data corresponding to the characteristic point comprises:

loading first data which correspond to data relating to the first link, into a storage unit so that the first data can be read directly from the storage unit and displayed when the first link is triggered by the switching operation.

Taking the first interface being a browsing interface of a browser application as an example, when the characteristic point is located within a first predetermined area on the browsing interface with a first link displayed therein, the first data to which the first link is pointed are pre-loaded according to an address carried by the first link.

In the embodiment of the application, according to the different loading sources, the approach for pre-loading the first data may comprises: local loading, or network loading, which will be described respectively below.

The first one is local loading.

That is, the electronic device comprises a pre-storage unit and a storage unit, and pre-loading first data corresponding to the characteristic point comprises:

reading first preparation data, which is pre-stored, corresponding to the characteristic point from the pre-storage unit;

decoding the first preparation data by a preset decoding algorithm to obtain the first data; and

storing the first data into the storage unit.

For example, the electronic device reads an image, which is pre-stored, corresponding to the characteristic point from the pre-storage unit.

The image is decoded in advance by an image decoding algorithm to obtain a decoded image. The image is stored into the storage unit to facilitate a quick display of the decoded image after the electronic device receives a switching operation.

Alternatively, the electronic device reads a compressed packet, which is pre-stored, corresponding to the characteristic point from the pre-storage unit.

The compressed packet is decompressed in advance by a decompressing algorithm to obtain decompressed data. The decompressed data is stored into the storage unit to facilitate a quick display of the decompressed data upon the electronic device receives a switching operation.

The second one is network loading.

That is, the first electronic device may comprise a communication unit and a storage unit, and pre-loading first data corresponding to the characteristic point comprises:

sending, by the communication unit, a loading request to a second electronic device connected with the first electronic device;

receiving first data sent from the second electronic device based on the loading request; and

storing the first data into the storage unit.

In a particular implementation, the first electronic device and the second electronic device may be connected based on a Long Term Evolution (LTE) system, Code Division Multiple Access (CDMA) system, Time Division-Synchronous Code Division Multiple Access (TD-SCDMA) system, or Bluetooth system, or connected based on wireless local network such as Wireless Fidelity (WIFI), etc., which is not limited in the application.

In the embodiment of the application, the storage unit may be a buffer unit.

in the embodiment of the application, in order to save the storage space of the storage unit, after pre-loading first data corresponding to the characteristic point, the method may further comprise:

deleting the first data if a first deletion condition is satisfied.

Particularly, the first deletion condition may comprise that the switching operation was not received for a preset duration of time after pre-loading of the first data.

The first deletion condition may also comprise: receiving a closing operation of closing the first application.

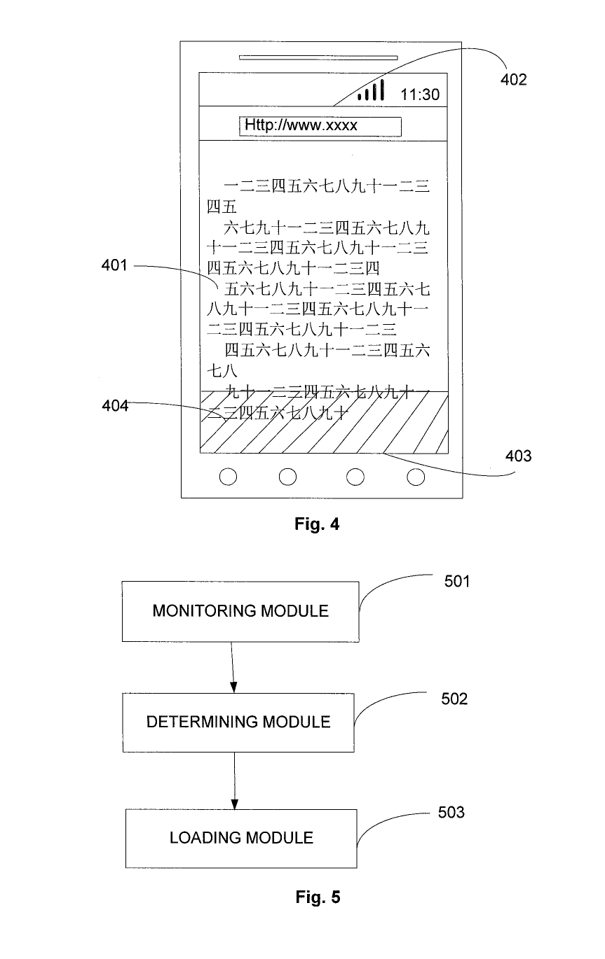

Finally, in order to have a better understanding of the information processing method according to the first embodiment of the application, taking the first electronic device being a tablet computer, the first interface being a browsing interface of a browser and the characteristic point being a visual focus point as an example, the solution of the first embodiment of the application will be described from the view of human-machine interaction, in connection with FIG. 4.

The user A, when browsing a long web page by using a tablet computer, firstly opens a browsing interface 401 of a browser, and then browses along the direction from the top side 402 to the bottom side 403 of the browsing interface 401.

When the user A browses the third data near the bottom side 403, the eye tracking apparatus on the tablet computer detects that the visual focus point focused by the eyes of the user enters the first predetermined area 404 identified by diagonal lines in FIG. 4.

When the duration of time that the visual focus point located within the first predetermined area 404 reaches 10 seconds, the tablet computer sends a loading request to the server of the current web page, and receives the data following the third data returned by the server and stores the data following the third data into the buffer.

Next, the user A touches the browsing interface 401 and moves the browsing interface 401 upwards. The tablet computer reads the data following the third data directly from the buffer, and displays the data in an area on the browsing interface 401 near the bottom side 403.

When the user A does not want to browse the web page any more, the user A closes the browser. The tablet computer deletes the data following the third data stored in the buffer.

Based on the same inventive conception, the application further provides a second embodiment.

### The Second Embodiment

In the second embodiment, an electronic device is provided, which is referred as a first electronic device below. In a practical implementation, the first electronic device may be an electronic device such as a smart phone, a tablet computer, a notebook computer or a smart watch, which will not be enumerated in this embodiment.

Referring to FIG. 5, FIG. 5 is a structural diagram of an electronic device according to the second embodiment of the application. The electronic device comprises:

a monitoring module 501 configured to monitor location information of a characteristic point with respect to a first interface when the first interface is displayed on the first electronic device;

a determining module 502 configured to determine whether the location information of the characteristic point satisfies a preset condition; and

a loading module 503 configured to keep the displayed content of the first interface unchanged, and pre-load first data corresponding to the characteristic point if the location information of the characteristic point satisfies the preset condition, so as to enable second content corresponding to the pre-loaded first data to be displayed on the electronic device, especially a display unit of the electronic device, upon the first electronic device receives a switching operation corresponding to the first data. It should be appreciated that each or a part or a combination in any manner of the monitoring module 501, the determining module 502 and the loading module 503 can be implemented by one or more processors of the electronic device.

In the embodiment of the application, the monitoring module 501 comprises:

a first collection unit configured to collect second data, the second data being data representative of a visual focus area of a viewer;

an analyzing unit configured to analyze the second data to determine a visual focus point with respect to the first interface; and

a first monitoring unit configured to monitor location information of the visual focus point with respect to the first interface.

In the embodiment of the application, the monitoring module 501 comprises:

a detection unit configured to detect a location point of a first operation with respect to the first interface, wherein the switching operation is a successive operation of the first operation, the first operation being used for determining a location corresponding to the switching operation before the switching operation is received; and

a second monitoring unit configured to monitor location information of the location point with respect to the first interface.

In the embodiment of the application, the determining module 502 is further configured to:

determine whether the characteristic point is located within a first predetermined area of the first interface; or

determine whether the time during which the characteristic point is located within the first predetermined area of the first interface has reached a preset duration of time.

In the embodiment of the application, the first predetermined area comprises: an area for which the distance from a preset side of the first interface is below a preset threshold; or an area with a first link displayed therein.

In the embodiment of the application, in the case that the first predetermined area comprises an area for which the distance from a preset side of the first interface is below a preset threshold, the loading module 503 is further configured to:

load the first data related to third data displayed in the first predetermined area into a storage unit, wherein the first data and the third data are preset data successively displayed on the first interface.

In the embodiment of the application, when the preset side comprises a first preset side and a second preset side, the first data are preset data previous to the third data if the distance between the characteristic point and the first preset side is below the preset threshold; and the first data are preset data following the third data if the distance between the characteristic point and the second preset side is below the preset threshold.

In the embodiment of the application, when the first predetermined area is an area with a first link displayed therein, the loading module 503 is further configured to:

load first data which correspond to data relating to the first link, into a storage unit so that the pre-loaded first data can be read directly from the storage unit and displayed when the first link is triggered by the switching operation.

In the embodiment of the application, the loading module 503 comprises:

a communication unit configured to send a loading request to a second electronic device, and receive first data sent from the second electronic device based on the loading request; and

a storage unit configured to store the first data.

The electronic device according to the present embodiment of the application and the information processing method according to the first embodiment are two aspects based on the same inventive conception. The implementation of the method has been described in detail above so that the structure and the implementation of the electronic device of the present embodiment can be clearly understood by one with ordinary skills in the art according to the foregoing description, and thus will not be described herein for the sake of simplicity.

The solutions according to embodiments of the application have at least the following technical effects or advantages:

1. the method and electronic device according to embodiments of the application monitor location information of a characteristic point with respect to the first interface and, when the location where the characteristic point is located satisfies a preset condition, pre-load first data corresponding to the characteristic point in advance, so that the time for loading the first data is saved and the pre-loaded first data is displayed on the first application interface directly when the first electronic device receives a switching operation corresponding to the characteristic point, thereby achieving the technical effect of improving the response speed of the switching operation.

2. the method and electronic device according to embodiments of the application monitor the visual focus point of the viewer on the first interface, and pre-load the first data corresponding to the location where the visual focus point is located when the location where the visual focus point is located satisfies a preset condition, and thus achieve the technical effect of improving intelligence of the pre-loading.

3. the method and electronic device according to embodiments of the application monitor the location point of the first operation prior to the switching operation with respect to the first interface, and pre-load the first data corresponding to the location where the location point is located when the location where the location point is located satisfies a preset condition, and thus achieve the technical effect of improving intelligence of the pre-loading.

One with ordinary skills in the art should understand that the embodiments of the application can be provided as methods, systems or computer program products. Accordingly, the application may take the form of full hardware embodiment, full software embodiment or embodiment combining software and hardware aspects. Furthermore, the application may take the form of computer program product implemented on one or more computer-usable storage media (comprise but do not limit to magnetic disks, CD-ROMs, optical memories, etc.) having computer-usable program code embodied thereon.

The application was described referring to the flowcharts and/or block diagrams of the methods, the devices (systems), and the computer program products according to the embodiment of the application. It should be understood that each flow and/or block in the flowcharts and/or block diagrams, and the combination of the flows and/or blocks in the flowcharts and/or block diagrams may be implemented by computer program instructions. These computer program instructions may be provided to a general purpose computer, a special purpose computer, a embedded processor or processors of other programmable data processing devices to product a machine, so that the instructions executed by the computers or the processors of other programmable data processing devices produce an apparatus for implementing the functions specified in one or more flows in the flowcharts and/or one or more blocks in the block diagrams.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in one or more flows in the flowcharts and/or one or more blocks in the block diagrams.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the function specified in one or more flows in the flowcharts and/or one or more blocks in the block diagrams.

Particularly, the computer program instructions corresponding to the information processing method of the embodiment of the application may be stored on storage media such as optical disc, hard disc, USB flash disc, and so on.

As for the information processing method provided by the first embodiment, the computer program instructions in the storage media which corresponds to the information processing method, when read or performed by an electronic device, comprise the following steps:

monitoring location information of a characteristic point with respect to a first interface when the first interface is displayed on the first electronic device;

determining whether the location information of the characteristic point satisfies a preset condition; and

keeping the displayed content of the first interface unchanged, and pre-loading first data corresponding to the characteristic point if the location information of the characteristic point satisfies the preset condition, so as to enable second content corresponding to the pre-loaded first data to be displayed on the first electronic device upon the first electronic device receiving a switching operation corresponding to the first data.

Optionally, the computer instructions stored in the storage media and corresponding to the step of monitoring location information of a characteristic point with respect to the first interface, when executed, comprise the following steps:

collecting second data, the second data being data representative of a visual focus area of a viewer;

analyzing the second data to determine a visual focus point with respect to the first interface; and

monitoring location information of the visual focus point with respect to the first interface.

Optionally, the computer instructions stored in the storage media and corresponding to the step of monitoring location information of a characteristic point with respect to the first interface, when executed, comprise the following steps:

detecting a location point of a first operation with respect to the first interface, wherein the switching operation is a successive operation of the first operation, the first operation being used for determining a location corresponding to the switching operation before the switching operation is received; and

monitoring location information of the location point with respect to the first interface.

Optionally, the computer instructions stored in the storage media and corresponding to the step of determining whether the location information of the characteristic point satisfies a preset condition, when executed, comprise the following steps:

determining whether the characteristic point is located within a first predetermined area of the first interface; or

determining whether the time during which the characteristic point is located within the first predetermined area of the first interface has reached a preset duration of time.

Optionally, the first predetermined area comprises:

an area for which the distance from a preset side of the first interface is below a preset threshold; or

an area with a first link displayed therein.

Optionally, when the first predetermined area comprises an area for which the distance from a preset side of the first interface is below a preset threshold, the computer instructions stored in the storage mediums and corresponding to the step of pre-loading first data corresponding to the characteristic point, when executed, comprise the following step:

loading the first data related to third data displayed in the first predetermined area into a storage unit, wherein the first data and the third data are preset data successively displayed on the first interface.

Optionally, when the preset side comprises a first preset side and a second preset side:

the first data are preset data previous to the third data if the distance between the characteristic point and the first preset side is below the preset threshold; and

the first data are preset data following the third data if the distance between the characteristic point and the second preset side is below the preset threshold.

Optionally, if the first predetermined area is an area with a first link displayed therein, the computer instructions stored in the storage mediums and corresponding to the step of pre-loading the first data corresponding to the characteristic point, when executed, comprise the following step:

loading the first data which correspond to data relating to the first link, into a storage unit so that the first data can be read directly from the storage unit and displayed when the first link is triggered by the switching operation.

Optionally, the computer instructions stored in the storage mediums and corresponding to the step of pre-loading first data corresponding to the characteristic point, when executed, comprise the following steps:

sending a loading request to a second electronic device connected with the first electronic device;

receiving the first data sent from the second electronic device based on the loading request; and

storing the first data in a storage unit.

Though the preferable embodiments of the application have been described, other alterations and modifications can be made once one with ordinary skills in the art knows the basic inventive conception. Therefore, the appended claims should be interpreted as including the preferable embodiments and all the alterations and modifications falling into the scope of the invention.

Obviously, one with ordinary skills in the art can make alterations and modifications without departing from the spirit and scope of the application. As such, if these alterations and modifications of the application fall into the scope of the claims of the application and equivalents thereof, the application intends to contain these alterations and modifications.

We claim:

1. An information processing method, comprising:
monitoring location information of a characteristic point with respect to a first interface displayed on a first electronic device;
determining whether the location information of the characteristic point satisfies a preset condition; and
keeping the displayed content of the first interface unchanged, and pre-loading first data corresponding to the characteristic point if the location information of the characteristic point satisfies the preset condition, so as to enable second content corresponding to the pre-loaded first data to be displayed on the first electronic device upon the first electronic device receiving a switching operation corresponding to said first data.

2. The method of claim 1, wherein monitoring the location information of the characteristic point with respect to the first interface comprises:
collecting second data, the second data being data representative of a visual focus area of a viewer;
analyzing the second data to determine a visual focus point with respect to the first interface; and
monitoring location information of the visual focus point with respect to the first interface.

3. The method of claim 1, wherein monitoring the location information of the characteristic point with respect to the first interface comprises:
detecting a location point of a first operation with respect to the first interface, wherein the switching operation is a successive operation of the first operation, the first operation being used for determining a location corresponding to the switching operation before the switching operation is received; and
monitoring location information of the location point with respect to the first interface.

4. The method of claim 1, wherein determining whether the location information of the characteristic point satisfies a preset condition comprises:
determining whether the characteristic point is located within a first predetermined area of the first interface; or
determining whether the time during which the characteristic point is located within the first predetermined area of the first interface has reached a preset duration of time.

5. The method of claim 4, wherein the first predetermined area comprises:
an area for which the distance from a preset side of the first interface is below a preset threshold; or
an area with a first link displayed therein.

6. The method of claim 5, wherein pre-loading the first data corresponding to the characteristic point comprises:
loading the first data related to third data displayed in the first predetermined area into a storage unit, wherein the first data and the third data are preset data successively displayed on the first interface.

7. The method of claim 6, wherein the preset side comprises a first preset side and a second preset side,
the first data are preset data previous to the third data if the distance between the characteristic point and the first preset side is below the preset threshold; and
the first data are preset data following the third data if the distance between the characteristic point and the second preset side is below the preset threshold.

8. The method of claim 5, wherein if the first predetermined area is an area with a first link displayed therein, pre-loading the first data corresponding to the characteristic point comprises:
loading the first data which correspond to data relating to the first link, into a storage unit so that the first data can be read directly from the storage unit and displayed when the first link is triggered by the switching operation.

9. The method of claim 1, wherein pre-loading the first data corresponding to the characteristic point comprises:
sending a loading request to a second electronic device connected with the first electronic device;
receiving the first data sent from the second electronic device based on the loading request; and
storing the first data in a storage unit.

10. The method of claim 1, wherein pre-loading the first data enables the second content corresponding to the first data to be displayed after a first period of time upon the first electronic device receives the switching operation corresponding to said first data, the first period of time being shorter than a second period of time required for displaying the second content after the switching operation is received in the case that said pre-loading is not performed.

11. An electronic device comprising:
a display unit for displaying a first interface;
a processor configured to:
monitor location information of a characteristic point with respect to the first interface;
determine whether the location information of the characteristic point satisfies a preset condition; and
keep the displayed content of the first interface unchanged, and pre-load first data corresponding to the characteristic point if the location information of the characteristic point satisfies the preset condition, so as to enable second content corresponding to the pre-loaded first data to be displayed via the display unit upon receiving a switching operation corresponding to the first data.

12. The electronic device of claim 11, wherein the processor is further configured to:
collect second data, the second data being data representative of a visual focus area of a viewer;
analyze the second data to determine a visual focus point with respect to the first interface; and
monitor location information of the visual focus point with respect to the first interface.

13. The electronic device of claim 11, wherein the processor is further configured to:
detect a location point of a first operation with respect to the first interface, wherein the switching operation is a successive operation of the first operation, the first operation being used for determining a location corresponding to the switching operation before the switching operation is received; and
monitor location information of the location point with respect to the first interface.

14. The electronic device of claim 11, wherein the processor is further configured to:
determine whether the characteristic point is located within a first predetermined area of the first interface; or
determine whether the time during which the characteristic point is located within the first predetermined area of the first interface has reached a preset duration of time.

15. The electronic device of claim 14, wherein if the first predetermined area comprises an area for which the distance from a preset side of the first interface is below a preset threshold, the processor is further configured to:
load the first data related to third data displayed in the first predetermined area into a storage unit, wherein the first data and the third data are preset data successively displayed on the first interface.

16. The electronic device of claim 14, wherein if the first predetermined area comprises an area with a first link displayed therein, the processor is further configured to:
load the first data which correspond to data relating to the first link, into the storage unit so that the pre-loaded first data can be read directly from the storage unit and displayed when the first link is triggered by the switching operation.

17. The electronic device of claim 11, wherein the processor is further configured to:
send a loading request to a second electronic device;
receive the first data sent from the second electronic device based on the loading request; and
store the first data in a storage unit.

18. The electronic device of claim 11, wherein the processor is further configured to pre-load the first data to enable the second content corresponding to the pre-loaded first data to be displayed after a first period of time upon receiving the switching operation, the first period of time being shorter than a second period of time required for displaying the second content after receiving the switching operation in the case that said pre-loading is not performed.
